(19) United States
(12) Patent Application Publication
(10) Pub. No.: US 2023/0096970 A1
(43) Pub. Date: Mar. 30, 2023

(54) RECIPROCATING LEASH FOR WALKING ANIMALS

(71) Applicant: Five23 Products, LLC, Omro, WI (US)

(72) Inventor: Brian C. Jankowski, Neenah, WI (US)

(73) Assignee: Five23 Products, LLC, Omro, WI (US)

(21) Appl. No.: 17/941,171

(22) Filed: Sep. 9, 2022

Related U.S. Application Data
(60) Provisional application No. 63/248,002, filed on Sep. 24, 2021.

(51) Int. Cl. A01K 27/00

(52) U.S. Cl. CPC A01K 27/004; A01K 27/008

(57) ABSTRACT

A reciprocating leash to walk animals. The leash includes a handle, a slip zone, and a cord. The slip zone is located at a cord end of the handle. The cord is located in the slip zone. A middle portion of the cord is defined between a left stop and a right stop. A left end portion of the cord is defined from the left stop to a left end of the cord and a right end portion of the cord is defined from the right stop to a right end of the cord. The middle portion passes through the slip zone and is movable in and out of the slip zone through a range of travel limited to between the left stop and the right stop. The left end and the right end each include an end clip to repeatably be connected to and released from animals.

### CROSS-REFERENCE TO RELATED APPLICATION

This application claims the benefit of U.S. Provisional Application No. 63/248,002, filed Sep. 24, 2021, and titled: RECIPROCATING LEASH FOR WALKING ANIMALS.

### TECHNICAL FIELD

This invention generally relates to devices for walking animals, and more particularly to a leash for walking two animals at the same time to accommodate the animals different walking speeds, styles and interests while on the walk.

### BACKGROUND

Taking an animal for a walk can be an enjoyable and healthy activity. However, when it comes to one person trying to take at least two animals for a walk at the same time, it can be a different story because the options to do so present several challenges. Existing options are to use a separate leash for each animal, or use one leash with multiple extensions each connected thereto and each extension operating independent of the other extension(s), or some other complicated configuration of multiple leashes. Thus, there is a need to address the deficiencies in the art to better achieve more desirable requirements and avoid negative ones, for one person to walk multiple animals with as little hardware as possible and as simple a leash structure as possible, and preferably in a way that is more consistent and reliable for such animal walking leash devices.

### SUMMARY

To address one or more deficiencies in the art and/or better achieve the desirable requirements for a dog leash, there is provided a reciprocating leash to walk animals. The leash includes a handle, a slip zone, and a cord. The slip zone is located at a cord end of the handle. The cord is located in the slip zone. A middle portion of the cord is defined between a left stop of the cord and a right stop of the cord. A left end portion of the cord is defined from the left stop of the cord to a left end of the cord. A right end portion of the cord is defined from the right stop of the cord to a right end of the cord. The middle portion of the cord passes through the slip zone and is movable in and out of the slip zone through a range of travel limited to between the left stop of the cord and the right stop of the cord. The left end of the cord and the right end of the cord each include an end clip to repeatably be connected to and released from animals.

In other aspects, there is disclosed a reciprocating leash to walk animals. The leash includes a handle, a slip zone, and a cord. The handle has an elongated shape and a hollow core portion. The slip zone is located at a cord end of the handle. The cord is located in the slip zone. A middle portion of the cord is defined between a left stop of the cord and a right stop of the cord. A left end portion of the cord is defined from the left stop of the cord to a left end of the cord. A right end portion of the cord defined from the right stop of the cord to a right end of the cord. The middle portion of the cord passes through the slip zone and is movable in and out of the slip zone through a range of travel limited to between the left stop of the cord and the right stop of the cord. The cord is movable as a whole unit when the middle portion of the cord is movable in and out of the slip zone through the range of travel limited to between the left stop of the cord and the right stop of the cord. The left end of the cord and the right end of the cord each include an end clip to repeatably be connected to and released from animals.

In yet other aspects, there is disclosed a reciprocating leash to walk animals. The leash includes a handle, a slip zone, and a cord. The handle has a hollow core portion. The slip zone is located at a cord end of the handle. The cord is located in the slip zone. A middle portion of the cord is defined between a left stop of the cord and a right stop of the cord. A left end portion of the cord is defined from the left stop of the cord to a left end of the cord. A right end portion of the cord is defined from the right stop of the cord to a right end of the cord. The middle portion of the cord passes through the slip zone and is movable in and out of the slip zone through a range of travel limited to between the left stop of the cord and the right stop of the cord. The cord is movable as a whole unit when the middle portion of the cord is movable in and out of the slip zone through the range of travel limited to between the left stop of the cord and the right stop of the cord. The middle portion of the cord in the slip zone is rotatable around a center axis of the handle. The left end of the cord and the right end of the cord each include an end clip to repeatably be connected to and released from animals.

Other aspects of the disclosure are directed to configurations and features for the handle, the slip zone and the cord, and combinations thereof.

### DESCRIPTION OF THE DRAWINGS

The invention may be more completely understood in consideration of the following detailed description of various features of the invention in connection with the accompanying drawings, in which:

FIG. 1 is a perspective view of a reciprocating leash for walking animals, for example two animals like dogs;

FIG. 2 is a close up perspective view of a portion of the leash seen in FIG. 1, showing a way to use the leash by passing a user's hand through a wrist strap connected with a handle and the user holding the handle in their hand and the wrist strap resting on the user's wrist to lower arm area;

FIGS. 3-5 are each a top view of the reciprocating leash seen in FIG. 1 showing the reciprocating action of a cord middle portion that passes through a slip zone at one end of the handle whereby a left end of the cord and a right end of the cord can be equal distance from the slip zone as seen in FIG. 3, or the cord left end closer to the slip zone than the cord right end as seen in FIG. 5, or the cord right end closer to the slip zone than the cord left end as seen in FIG. 4, and FIGS. 4 and 5 showing the extent of the range of travel for the cord middle portion relative to the slip zone when the cord is relaxed and not under tension being stretched;

FIG. 6 is an enlarged and close up view of a portion of the leash seen in FIG. 3 to more clearly show the cord stops and their accompanying stop balls, both of which define the extent, or maximum, of the range of travel of the cord middle portion relative to the slip zone;

FIG. 7 is another view of the leash seen in FIG. 6 and exactly the same except now showing the positionability of the stop balls slidably along the cord middle portion;

FIG. 8 is a bottom close up view of the slip zone at one end of the handle seen in FIG. 3;

FIG. 9 is a perspective view of the slip zone and internal mechanism that connects the slip zone to the handle at one end of the handle and connects the wrist strap to the handle at an opposite end of the handle;

FIG. 10 is another perspective of that seen in FIG. 9 but also showing more of a middle area of the internal mechanism;

FIG. 11 is a cross-sectional view generally taken along the line A-A in FIG. 8, to show the relationship of the slip zone and internal mechanism to each other and with the handle;

FIG. 12 is a close up and enlarged perspective view of a portion of the leash seen in FIG. 1, focusing on the animal waste bags and their dispensing slot;

FIG. 13 is a further view of a portion of the leash seen in FIG. 12 but here showing more the end of the handle and an exemplary way where and how the wrist strap can be connected with the handle; and,

FIG. 14 is a further view of the portion of the leash seen in FIG. 13 but here showing the wrist strap disconnected from the handle and a roll of animal waste bags protruding from a storage area of the handle and demonstrating how the roll of animal waste bags can be inserted into, and the empty roll removed from, the storage area of the handle.

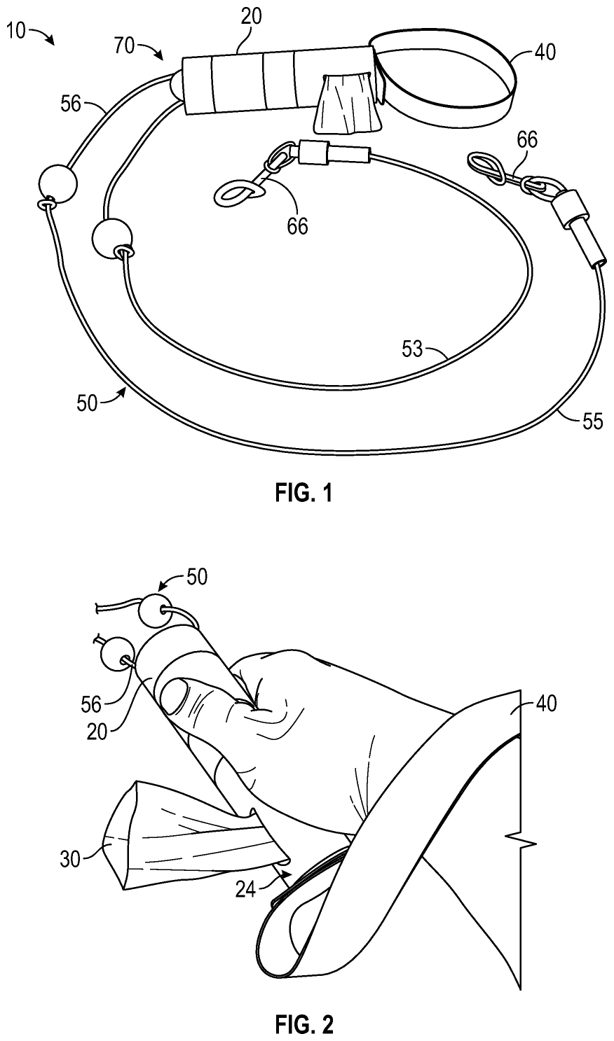

The drawings show some but not all embodiments. The elements depicted in the drawings are illustrative and not necessarily to scale, and the same (or similar) reference numbers denote the same (or similar) features throughout the drawings, though all the same (or similar) features are not always separately numbered to help avoid over numbering and obscuring what the drawings are disclosing.

### DETAILED DESCRIPTION

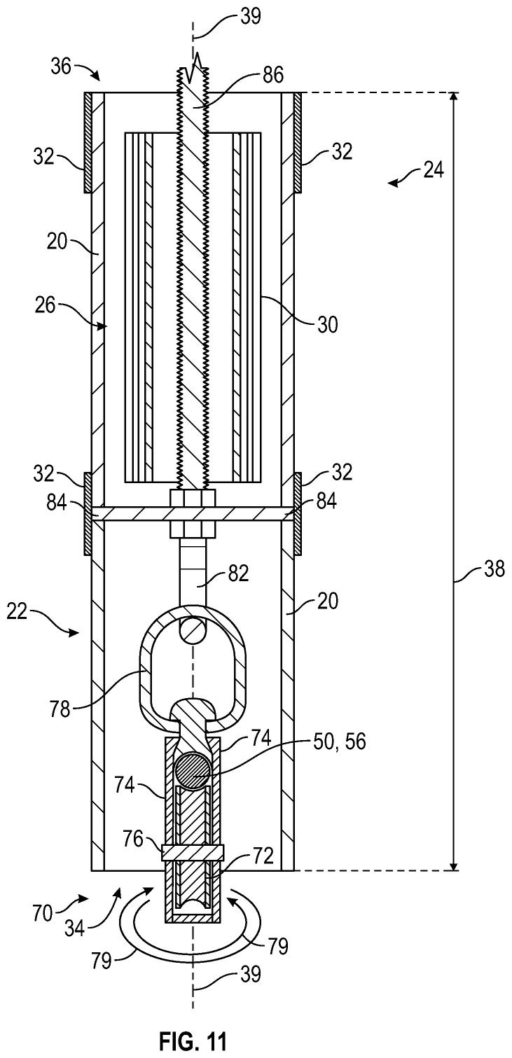

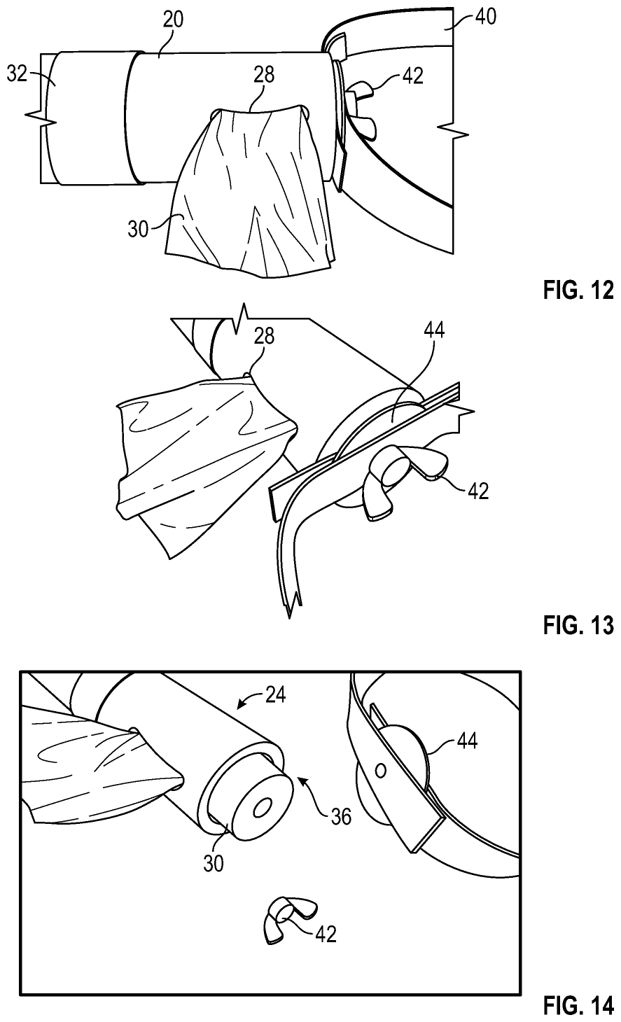

In accordance with the practice of our innovative reciprocating dog leash 10 for walking animals, as seen in the Figures, there is a handle 20. For example, handle 20 can be, preferably, an elongated and/or hollow tube, that is a cylinder or most any geometric shape that will function as taught herein. More preferably, the handle has a hollow core portion, and even more preferably the hollow core portion extends along a length 38 of the handle, and most preferably the hollow core portion extends along substantially an entirety of the length 38 of the handle. For example, this can be hollow core portion 34 located at and within cord end 22 and/or hollow core portion 36 located at and within strap end 24. As seen in FIGS. 9-11, most preferably, the hollow core portion is everywhere inside handle 20 except at plate 84. A wrist strap 40 can be connected with handle 20 at a strap end 24 of the handle. The strap 40 can be an adjustable strap or fixed diameter strap, and is preferably connected to strap end 24 in a selectively removable way such as with a center threaded bolt 86 and a wing nut 42 screwable therewith, and even more preferably using a washer 44 to better connect strap 40 to strap end 24 of the handle 20, for example as shown in FIGS. 11-14.

In use, a user can use the leash 10 with or without strap 40, and preferably with strap 40 as previously discussed. The user holds handle 20 (e.g., FIG. 2), generally closer to the strap end 24 and spaced from cord end 22. Handle 20 may be one continuous tube from end 22 to end 24, or it may be two (or more) tubes connected together (e.g., FIG. 11), either permanently connected together or selectively removably connected together, and generally connected together except when desired to separate a part or portion of the handle. As seen in FIG. 11, strap end 24 can be glued to plate 84, as can be cord end 22 also glued to plate 84, as well as tape 32 (e.g., reflective tape) wrapped around the circumference of the handle to also help secure the handle ends together and hide plate 84.

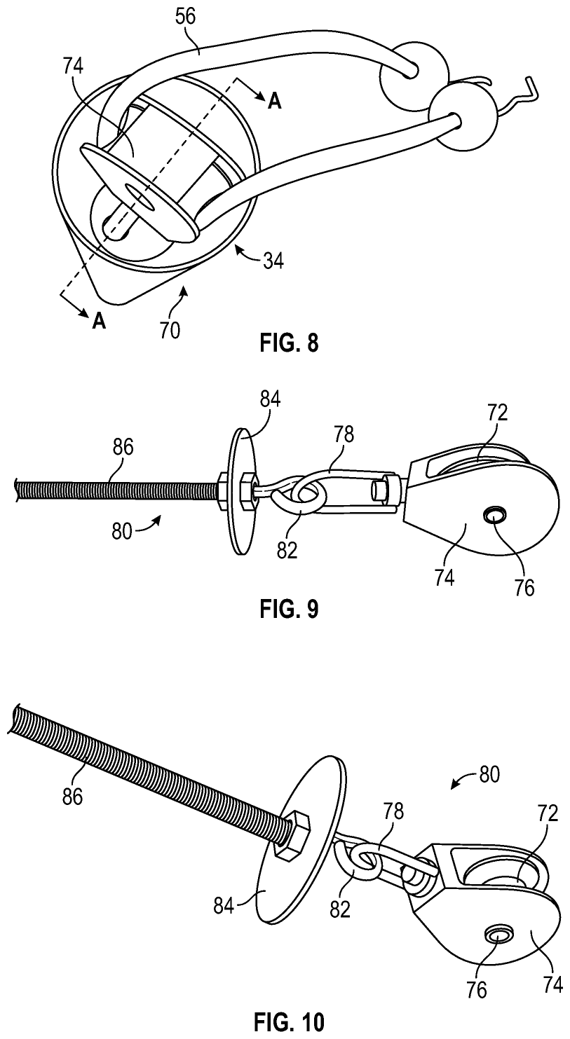

At the handle cord end 22 is where a cord 50 restrictively yet moveably connects with the handle 20 via slip zone 70 located at the cord end 22 of the handle 20, see FIGS. 8-11. Importantly, the cord 50 needs to move in and out of slip zone 70 when the leash is used to walk animals. For example, slip zone 70 can be any guiding hole that the cord can pass through and slide in and out for the reasons discussed further herein. Preferably, a conventional pulley 72 is rotatably secured in housing 74 by a pulley pin 76, and can provide the guiding hole and even more preferably the pulley is a wheel itself that rotates when the cord passes into and out of the guiding hole, i.e., the pulley path for cord 50. Additionally, preferably, the handle 20 has hollow core portion 34 at the cord end of the handle and the pulley 72 is located in the hollow core portion 34. Further in this regard, more preferably, substantially an entirety of pulley 72 is located in the hollow core portion 34. For example, this can aid to protect the wheel of the pulley and the passage of the cord middle portion 56 through the slip zone and relative to the pulley.

The slip zone, and the pulley as an example, preferably has attached to housing 74 a rotatable top loop 78 such that the top loop can be connected with an internal mechanism 80 that maintains the top loop and pulley in place relative to the handle. For example, a center threaded bolt 86 can connect with plate 84 by nuts screwed on either side of plate 84, and the plate connected with the handle, preferably rigidly connected at least temporarily, and even permanently unless removability is desired. Further in this regard, preferably, slip zone 70 (e.g., the pulley and its parts 72, 74, 76, relative to loop 78 when loop 78 is fixed relative to handle 20 vie connection with eyelet 82 as part of center bolt 86) can rotate around the center axis 39 of the handle, in direction of rotation 79 for 360 degrees in each direction. For example, this can enable the middle portion 56 of the cord in the slip zone 70 to be rotatable around center axis 39 of the handle 20 relative to a fixed position of the handle (i.e., when the handle is held by the user, e.g., FIG. 2). That is, top loop 78 is rotatable relative to housing 74 and pulley 72, and said in the converse, pulley 72 and its housing 74 are rotatable relative to top loop 78 which is relatively fixed with handle 20 via eyelet 82 as described above. This rotation is advantageous so the cord passing through the slip zone does not become twisted on itself. And, the cord does not become twisted because the slip zone rotates around center axis 39 to “untwist” the cord whenever the walking animals should happen to twist it up by their walking paths that cause the cord ends 52, 54 to twist around each other. Further in this regard, this can enable the middle portion 56 of the cord in the slip zone 70 to be rotatable around center axis 39 of the handle relative to the fixed position of the handle. Additionally, preferably, this can also enable the left end portion 53 of the cord and the right end portion 55 of the cord to be together rotatable around the center axis 39 of the handle relative to the fixed position of the handle, and most preferably doing this in conjunction with the middle portion 56 of the cord. All this rotational movement around the center axis 39 further aiding the two end portions 53, 55 to more likely remain untangle and untwisted together, so each can more freely move independent of the other end portion.

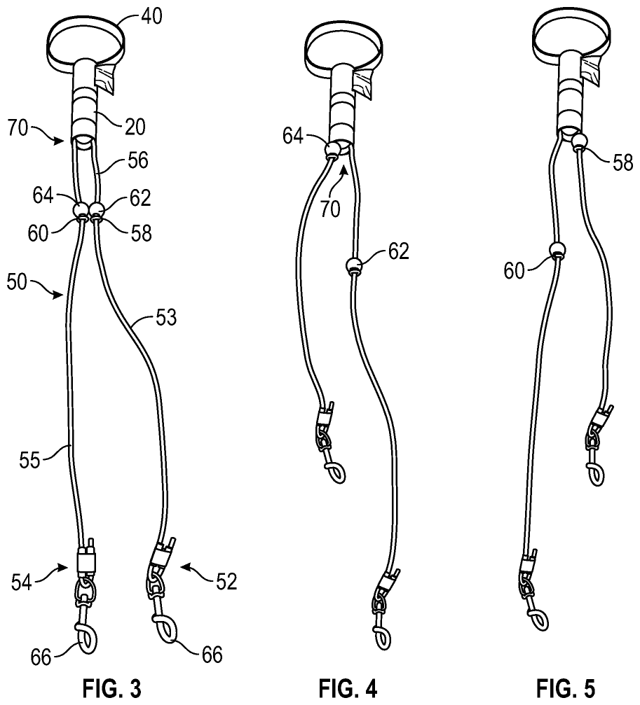

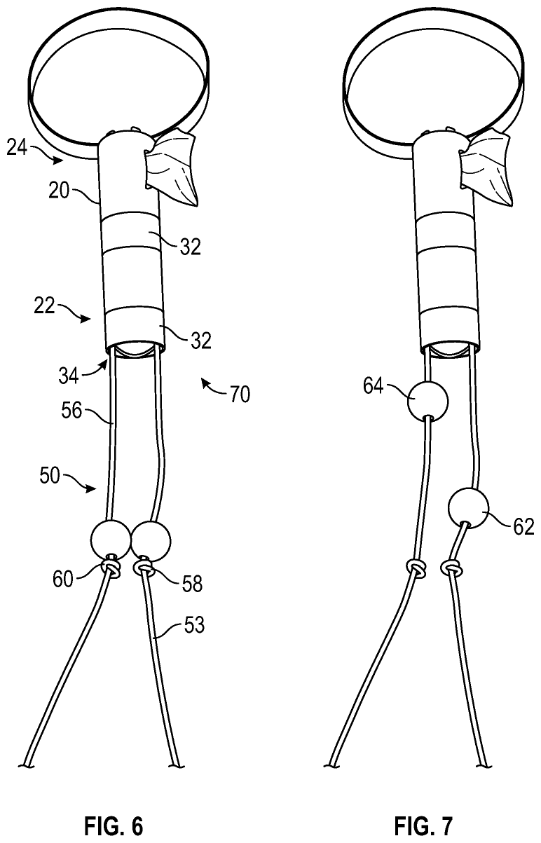

Referring to FIGS. 3-7, one can better see how the cord 50 interacts with the handle 20 and slip zone 70. Cord 50 has a cord left end 52 and a cord right end 54. Also, there is left end portion 53 of the cord defined from the left stop 58 of the cord to the left end 52 of the cord. Similarly, there is right end portion 55 of the cord defined from the right stop 60 of the cord to the right end 54 of the cord. Preferably each end 52, 54 has a conventional end clip 66 connected to it, and this way an animal can be repeatably connected and released from the cord when desired. As used herein, the “end clip” can be any structure that allows an animal to be repeatably connected and released from the cord, including hook and loop mating material, snaps, clips, clips with a spring action or merely the cord end used to tie the cord to itself to secure the animal thereto. Cord 50 also has cord middle portion 56 that is important to the invention. Middle portion 56 is defined by and between cord left stop 58 and cord right stop 60. Stops 58 and 60 could be any structure that limits movement of the middle portion relative to the slip zone 70 for some select middle portion of cord 50. For example, a knot in the cord, or one or more of a knot and/or a stop ball 62 and stop ball 64 or any other structure or assembly combined with the cord or slip zone, can limit travel of the cord through the slip zone to the middle portion of the cord.

Without being limited by a theory of understanding, the inventors have surprisingly found the middle portion of the cord, namely its limited travel extent relative to the slip zone, dramatically enhances the ability to and enjoyment of walking two animals, especially because two animals rarely walk with the same speed, style and paths, and so the middle portion helps accommodate these differences for each animal and the user walking the animals. In use, the cord is movable as a whole unit (e.g., including the entire length from end 52 to end 54) when the middle portion 56 is movable in and out of the slip zone 70 through the range of travel limited to between the left stop 58 and the right stop 60, though only the middle portion 56 can travel in and out of the slip zone 70. Additionally, preferably, the cord has at least some elastic property in its length to be extensible and automatically retractable, to further accommodate walking two animals and the differences they display when on a walk. More preferrable, the entire cord has this elastic property, or at least the end portions 53, 55, and the middle portion can each be elastic and/or non-elastic, and collectively be, for segments correlating to 53/56/54, these permutations: elastic/elastic/elastic, elastic/elastic/non-elastic, elastic/non-elastic/elastic, elastic/non-elastic/non-elastic, non-elastic/elastic/elastic, non-elastic/non-elastic/elastic, or non-elastic/non-elastic/non-elastic. Further in this regard, preferably, at least one of the left end portion 53 of the cord and the right end portion 55 of the cord is movable away from the handle 20 even further when the middle portion 56 of the cord is at a maximum range of travel limited by either the left stop 62 of the cord or the right stop 64 of the cord. That is, in this preferred configuration, at least one segment of the cord needs to be elastic to enable such added movement away from the handle when the maximum range of travel is limited by one of the stops 62, 64. Yet further in this regard, and more preferable, the reciprocating leash 10 can provide a retraction force relative to the animals connected to the cord ends, anytime the cord is pulled beyond its relaxed length. Additionally, or alternately, one member of the left end portion 53 of the cord and the right end portion 55 of the cord is elastic and one member of the left end portion 53 of the cord and the right end portion 55 of the cord is non-elastic.

As seen in the figures, the cord 50 is in a relaxed state, i.e., not stretched from its original as formed condition and length, regardless its elasticity or not. For example, the cord can be a ⅛ inch thick to a 5/16 inch thick conventional elastic cord-like material, such as a bungee cord, that is flexible and easily conformable around the pulley 72 and to pass through the slip zone. As another example, cord 50 when elastic can have a stretch factor such that it extends from about one to three times its relaxed length depending on strength of the cord used. For example, cord 50 can stretch one to two times relaxed length (e.g., for a 3/16 inch diameter bungee cord) for a small to medium size animal such as a dog. However, for larger animals/dogs, a stronger (and likely thicker) elastic cord can be used, and stretch can be from about one to six times its relaxed length. As another example, when both ends 52, 54 are simultaneously stretched they can extend to about six feet each. When one end 52, 54 is retracted and its relaxed length, it can be about three feet long while the other end 54, 52 can be simultaneously stretched and extended to be about seven to eight feet long. That is, this ability to separately stretch and relax each end 52, 54 is due to the respective stop balls 62, 64 preventing the other end 54, 52 from being shorter than cord 50′s relaxed length of paired cord stop 58 with end 52, and paired cord stop 60 with end 54, respectively, depending on whether one or both ends 52, 54 are being stretch. Further, for example, middle portion 56 can be about six inches of elastic material between the stops 58, 60 that have their pivot point around slip zone 70, namely, pulley 74 in this example. So, when middle portion 56 is stretched, it can add another one to two feet of length to each of the end pairs 58, 52 and 60, 54, or some split between the two ends 52, 54.

Turning to FIGS. 11-14, for example, there is seen an optional feature of leash 10, namely, animal waste bags 30 in storage area 26 that can be accessed through dispensing slot 28 in communication with the storage area 26 to dispense bags therethrough when desired. Preferably the bags are in a roll and the roll can be put into the handle 20 at end 24 and slide over center bolt 86. The washer 44 and wing nut 42 (or any similar securing materials) can be used to selectively secure closed the storage area 26 and/or connect strap 40 to handle 20, and then open storage area 26 when desired to change out the waste bag roll or store something else in area 26.

Additional discussion of embodiments in various scopes now follows:
A. A reciprocating leash to walk animals. The leash includes a handle, a slip zone, and a cord. The slip zone is located at a cord end of the handle. The cord is located in the slip zone. A middle portion of the cord is defined between a left stop of the cord and a right stop of the cord. A left end portion of the cord is defined from the left stop of the cord to a left end of the cord. A right end portion of the cord is defined from the right stop of the cord to a right end of the cord. The middle portion of the cord passes through the slip zone and is movable in and out of the slip zone through a range of travel limited to between the left stop of the cord and the right stop of the cord. The left end of the cord and the right end of the cord each include an end clip to repeatably be connected to and released from animals.
B. A reciprocating leash to walk animals. The leash includes a handle, a slip zone, and a cord. The handle has an elongated shape and a hollow core portion. The slip zone is located at a cord end of the handle. The cord is located in the slip zone. A middle portion of the cord is defined between a left stop of the cord and a right stop of the cord. A left end portion of the cord is defined from the left stop of the cord to a left end of the cord. A right end portion of the cord defined from the right stop of the cord to a right end of the cord. The middle portion of the cord passes through the slip zone and is movable in and out of the slip zone through a range of travel limited to between the left stop of the cord and the right stop of the cord. The cord is movable as a whole unit when the middle portion of the cord is movable in and out of the slip zone through the range of travel limited to between the left stop of the cord and the right stop of the cord. The left end of the cord and the right end of the cord each include an end clip to repeatably be connected to and released from animals.
C. A reciprocating leash to walk animals. The leash includes a handle, a slip zone, and a cord. The handle has a hollow core portion. The slip zone is located at a cord end of the handle. The cord is located in the slip zone. A middle portion of the cord is defined between a left stop of the cord and a right stop of the cord. A left end portion of the cord is defined from the left stop of the cord to a left end of the cord. A right end portion of the cord is defined from the right stop of the cord to a right end of the cord. The middle portion of the cord passes through the slip zone and is movable in and out of the slip zone through a range of travel limited to between the left stop of the cord and the right stop of the cord. The cord is movable as a whole unit when the middle portion of the cord is movable in and out of the slip zone through the range of travel limited to between the left stop of the cord and the right stop of the cord. The middle portion of the cord in the slip zone is rotatable around a center axis of the handle. The left end of the cord and the right end of the cord each include an end clip to repeatably be connected to and released from animals.
D. The reciprocating leash of any of the prior embodiments, wherein the handle is elongated.
E. The reciprocating leash of any of the prior embodiments, further comprising a wrist strap connected with a strap end of the handle.
F. The reciprocating leash of any of the prior embodiments, wherein the wrist strap is selectively removably connected with the strap end of the handle.
G. The reciprocating leash of any of the prior embodiments, wherein the handle has a hollow core portion.
H. The reciprocating leash of any of the prior embodiments, wherein the hollow core portion extends along a length of the handle.
I. The reciprocating leash of any of the prior embodiments, wherein the hollow core portion extends along substantially an entirety of the length of the handle.
J. The reciprocating leash of any of the prior embodiments, wherein the cord is movable as a whole unit when the middle portion is movable in and out of the slip zone through the range of travel limited to between the left stop and the right stop.
K. The reciprocating leash of any of the prior embodiments, wherein at least one of the left end portion of the cord and the right end portion of the cord is movable away from the handle even further when the middle portion of the cord is at a maximum range of travel limited by either the left stop of the cord or the right stop of the cord.
L. The reciprocating leash of any of the prior embodiments, wherein the cord is elastic along a length of the cord between the left end of the cord and the right end of the cord.
M. The reciprocating leash of any of the prior embodiments, wherein substantially an entire length of the cord is elastic.
N. The reciprocating leash of any of the prior embodiments, wherein the middle portion of the cord is non-elastic.
O. The reciprocating leash of any of the prior embodiments, wherein at least one of the left end portion of the cord and the right end portion of the cord is elastic.
P. The reciprocating leash of any of the prior embodiments, wherein both the left end portion of the cord and the right end portion of the cord are elastic.
Q. The reciprocating leash of any of the prior embodiments, wherein one member of the left end portion of the cord and the right end portion of the cord is elastic and one member of the left end portion of the cord and the right end portion of the cord is non-elastic.
R. The reciprocating leash of any of the prior embodiments, further comprising a waste bag storage area inside the handle and a dispensing slot in the handle to access the waste bag storage area.
S. The reciprocating leash of any of the prior embodiments, wherein the waste bag storage area includes a bolt extending through the waste bag storage area and designed to mount a roll of waste bags on the bolt and designed to dispense bag from the waste bag storage area through the dispensing slot.
T. The reciprocating leash of any of the prior embodiments, wherein the slip zone includes a pulley and the middle portion of the cord engages the pulley when the middle portion of the cord passes through the slip zone and is movable in and out of the slip zone through the range of travel limited to between the left stop and the right stop.
U. The reciprocating leash of any of the prior embodiments, wherein the handle has a hollow core portion at the cord end of the handle and the pulley is located in the hollow core portion.
V. The reciprocating leash of any of the prior embodiments, wherein substantially an entirety of the pulley is located in the hollow core portion.
W. The reciprocating leash of any of the prior embodiments, wherein the pulley and the middle portion of the cord engaged with the pulley is rotatable around a center axis of the handle relative to a fixed position of the handle.
X. The reciprocating leash of any of the prior embodiments, wherein the middle portion of the cord in the slip zone is rotatable around a center axis of the handle relative to a fixed position of the handle.
Y. The reciprocating leash of any of the prior embodiments, wherein the left end portion of the cord and the right end portion of the cord are together rotatable around the center axis of the handle relative to a fixed position of the handle in conjunction with the middle portion of the cord.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The invention includes the description, examples, features, embodiments, and drawings disclosed; but it is not limited to such description, examples, features embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the animal leash arts, and all such modifications and other embodiments are intended and deemed to be within the scope of the invention.

What is claimed is:

1. A reciprocating leash to walk animals comprising:
a handle;
a slip zone located at a cord end of the handle;
a cord located in the slip zone, a middle portion of the cord defined between a left stop of the cord and a right stop of the cord, a left end portion of the cord defined from the left stop of the cord to a left end of the cord and a right end portion of the cord defined from the right stop of the cord to a right end of the cord, and the middle portion of the cord passes through the slip zone and is movable in and out of the slip zone through a range of travel limited to between the left stop of the cord and the right stop of the cord; and,
the left end of the cord and the right end of the cord each include an end clip to repeatably be connected to and released from animals.

2. The reciprocating leash of claim 1, wherein the handle is elongated.

3. The reciprocating leash of claim 1, further comprising a wrist strap connected with a strap end of the handle.

4. The reciprocating leash of claim 3, wherein the wrist strap is selectively removably connected with the strap end of the handle.

5. The reciprocating leash of claim 1, wherein the handle has a hollow core portion.

6. The reciprocating leash of claim 5, wherein the hollow core portion extends along a length of the handle.

7. The reciprocating leash of claim 6, wherein the hollow core portion extends along substantially an entirety of the length of the handle.

8. The reciprocating leash of claim 1, wherein the cord is movable as a whole unit when the middle portion is movable in and out of the slip zone through the range of travel limited to between the left stop and the right stop.

9. The reciprocating leash of claim 8, wherein at least one of the left end portion of the cord and the right end portion of the cord is movable away from the handle even further when the middle portion of the cord is at a maximum range of travel limited by either the left stop of the cord or the right stop of the cord.

10. The reciprocating leash of claim 1, wherein the cord is elastic along a length of the cord between the left end of the cord and the right end of the cord.

11. The reciprocating leash of claim 10, wherein substantially an entire length of the cord is elastic.

12. The reciprocating leash of claim 10, wherein the middle portion of the cord is non-elastic.

13. The reciprocating leash of claim 12, wherein at least one of the left end portion of the cord and the right end portion of the cord is elastic.

14. The reciprocating leash of claim 13, wherein both the left end portion of the cord and the right end portion of the cord are elastic.

15. The reciprocating leash of claim 13, wherein one member of the left end portion of the cord and the right end portion of the cord is elastic and one member of the left end portion of the cord and the right end portion of the cord is non-elastic.

16. The reciprocating leash of claim 1, further comprising a waste bag storage area inside the handle and a dispensing slot in the handle to access the waste bag storage area.

17. The reciprocating leash of claim 16, wherein the waste bag storage area includes a bolt extending through the waste bag storage area and designed to mount a roll of waste bags on the bolt and designed to dispense bag from the waste bag storage area through the dispensing slot.

18. The reciprocating leash of claim 1, wherein the slip zone includes a pulley and the middle portion of the cord engages the pulley when the middle portion of the cord passes through the slip zone and is movable in and out of the slip zone through the range of travel limited to between the left stop and the right stop.

19. The reciprocating leash of claim 18, wherein the handle has a hollow core portion at the cord end of the handle and the pulley is located in the hollow core portion.

20. The reciprocating leash of claim 19, wherein substantially an entirety of the pulley is located in the hollow core portion.

21. The reciprocating leash of claim 18, wherein the pulley and the middle portion of the cord engaged with the pulley is rotatable around a center axis of the handle relative to a fixed position of the handle.

22. The reciprocating leash of claim 1, wherein the middle portion of the cord in the slip zone is rotatable around a center axis of the handle relative to a fixed position of the handle.

23. The reciprocating leash of claim 22, wherein the left end portion of the cord and the right end portion of the cord are together rotatable around the center axis of the handle relative to a fixed position of the handle in conjunction with the middle portion of the cord.

24. A reciprocating leash to walk animals comprising:
a handle having an elongated shape and a hollow core portion;
a slip zone located at a cord end of the handle;
a cord located in the slip zone, a middle portion of the cord defined between a left stop of the cord and a right stop of the cord, a left end portion of the cord defined from the left stop of the cord to a left end of the cord and a right end portion of the cord defined from the right stop of the cord to a right end of the cord, the middle portion of the cord passes through the slip zone and is movable in and out of the slip zone through a range of travel limited to between the left stop of the cord and the right stop of the cord, and the cord is movable as a whole unit when the middle portion of the cord is movable in and out of the slip zone through the range of travel limited to between the left stop of the cord and the right stop of the cord; and,
the left end of the cord and the right end of the cord each include an end clip to repeatably be connected to and released from animals.

25. A reciprocating leash to walk animals comprising:
a handle having a hollow core portion;
a slip zone located at a cord end of the handle;
a cord located in the slip zone, a middle portion of the cord defined between a left stop of the cord and a right stop of the cord, a left end portion of the cord defined from the left stop of the cord to a left end of the cord and a right end portion of the cord defined from the right stop of the cord to a right end of the cord, the middle portion of the cord passes through the slip zone and is movable in and out of the slip zone through a range of travel limited to between the left stop of the cord and the right stop of the cord, the cord is movable as a whole unit when the middle portion of the cord is movable in and out of the slip zone through the range of travel limited to between the left stop of the cord and the right stop of the cord, and the middle portion of the cord in the slip zone is rotatable around a center axis of the handle; and,
the left end of the cord and the right end of the cord each include an end clip to repeatably be connected to and released from animals.
